(19) United States
(12) Patent Application Publication
(10) Pub. No.: US 2024/0396459 A1
(43) Pub. Date: Nov. 28, 2024

(54) DC/DC multi-stage power converter

(71) Applicant: Infineon Technologies Austria AG, Villach (AT)

(72) Inventor: Nyan PAING SOE, Singapore (SG)

(21) Appl. No.: 18/669,846

(22) Filed: May 21, 2024

(30) Foreign Application Priority Data
May 23, 2023 (DE) 102023204774.8

(51) Int. Cl. H02M 3/335; H02M 3/00

(52) U.S. Cl. CPC H02M 3/33569; H02M 3/01

(57) ABSTRACT

A power converter is presented. The power converter may be configured to convert an input voltage into an output voltage. The power converter May comprise a switching bridge circuit. The power converter may comprise a transformer with primary windings, first secondary windings connected between a first transformer terminal and a second transformer terminal, and second secondary windings connected between the second transformer terminal and a third transformer terminal. The power converter may comprise a resonant tank circuit comprising the primary windings of the transformer. The power converter may comprise a buck power converter circuit coupled between the first secondary windings and an output of the power converter.

### RELATED APPLICATION

This application claims priority to earlier filed Germany filed Patent Application Serial Number 102023204774.8 entitled “A DC/DC Multi-Stage Power Converter,” (Attorney Docket No. 2023P00902DE), filed on May 23, 2023, the entire teachings of which are incorporated herein by this reference.

### TECHNICAL FIELD

The present document relates to direct current/direct current (DC/DC) power converters. In particular, the present document relates LLC-based DC/DC power converters comprising two or more stages.

### BACKGROUND

Conventional power converters can be configured to provide power to a respective load.

### BRIEF DESCRIPTION OF EXAMPLES

Examples as discussed herein provide a novel DC/DC power converter. In particular, one example as discussed herein provides a DC/DC power converter capable of achieving a wide output voltage range with a low number of switching elements. Further, another example as discussed herein reduces the required voltage rating of some of the switching elements.

According to an aspect, a power converter may be configured to convert an input voltage into an output voltage. The power converter may comprise a switching bridge circuit. The power converter may comprise a transformer with primary windings, first secondary windings connected between a first transformer terminal and a second transformer terminal, and second secondary windings connected between the second transformer terminal and a third transformer terminal. The power converter may comprise a resonant tank circuit comprising the primary windings of the transformer. The power converter may comprise a buck power converter circuit coupled between the first secondary windings and an output of the power converter. The output of the power converter may be a partial output of the power converter. As will be evident from the following description, the overall output of the power converter may be formed by said partial output and another partial output of the power converter.

The primary windings may be on a primary side of the transformer, and the first secondary windings and the second secondary windings may be on a secondary side of the transformer. The windings on the primary side of the transformer may be galvanically isolated from the windings on the secondary side of the transformer. For example, the transformer may be a planar transformer for optimizing the overall size of the power converter. The first secondary windings and the second secondary windings may have the same number of turns. The first secondary windings and the second secondary windings may be connected to create center-tap configuration. The buck power converter circuit may be coupled between the first transformer terminal and the output of the power converter. The buck power converter may not need an input capacitor, which may be an advantage.

The buck power converter circuit may comprise a first buck switch coupled between an input of the buck power converter circuit and a switching node, a second buck switch coupled between the switching node and the second transformer terminal, and an inductive element between the switching node and a first output node of the power converter. The transformer terminal may be a common terminal of the first secondary windings and the second secondary windings.

The buck switches may be implemented with any suitable devices, such as, for example, metal-oxide-semiconductor field effect transistors MOSFETs, insulated-gate bipolar transistors IGBTs, MOS-gated thyristors, or any other suitable power devices. For instance, the buck switches may be implemented using a III-V compound semiconductor material such as e.g. GaN-high-electron-mobility transistors HEMTs. Each buck switch may have a gate to which a respective driving voltage/current or control signal may be applied to turn the buck switch on (i.e. to close the buck switch) or to turn the buck switch off (i.e. to open the buck switch).

The inductive element may be e.g. an inductor or another device capable of storing magnetic energy in a magnetic field.

The first output node may be e.g. a reference potential. Throughout this document, the term “reference potential” is meant in its broadest possible sense. In particular, the reference potential is not limited to ground i.e. a reference potential with a direct physical connection to earth or a voltage of 0V. Rather, the term “reference potential” may refer to any reference point to which and from which electrical currents may flow or from which voltages may be measured. Moreover, it should be mentioned that the reference potentials mentioned in this document may not necessarily refer to the same physical contact. Instead, the reference potentials mentioned in this document may relate to different physical contacts although reference is made to “the” reference potential for ease of presentation.

The buck power converter circuit may be also denoted as synchronous buck power converter circuit. The output voltage of the buck power converter circuit may be lower than its input voltage, and the output current of the buck power converter circuit may be higher than its input current. The power converter may be configured to determine a switching state of the synchronous buck power converter circuit based on the output voltage of the power converter circuit. More specifically, the power converter may be configured to adjust a duty-cycle of the buck power converter circuit based on the output voltage of the power converter. That is, the buck power converter circuit may be operated in closed loop operation. To this end, the buck power converter circuit may comprise a feedback loop for sensing the output voltage, comparing the output voltage with a reference value, and for generating a control signal for controlling the switching behavior (e.g. the duty cycle) of the first and the second switch of the buck power converter circuit.

In contrast, the power converter may be configured to set a fixed duty-cycle (such as e.g. 50%) of the switching bridge circuit independent of the output voltage. Hence, the switching bridge circuit may be operated without feedback control in open loop operation.

Similarly, the power converter may be configured set a fixed duty-cycle (such as e.g. 50%) of the rectifier switches (which will be described in the following description in more detail) independent of the output voltage. Again, said rectifier switches may be controlled in open loop operation without any feedback control. The duty cycle of the rectifier switches and the duty cycle of the switching bridge circuit may be the same.

The buck power converter circuit, the rectifier switches and the switching bridge circuit may be operated at the same switching frequency of e.g. 500 KHz. Alternatively, different switching frequencies may be used. But in that case, it may be recommendable to deploy an input capacitor at the input of buck power converter circuit.

In summary, the buck power converter circuit, the rectifier switches and the switching bridge circuit may be operated using pulse width modulation (PWM) signals with the same frequency. The PWM signals of the rectifier switches and the switching bridge circuit may have a fixed duty cycle, and the PWM signal of the buck power converter circuit may have variable, output-voltage-dependent duty cycle which is equal to or smaller than the duty cycle of the PWM signals of the rectifier switches and the switching bridge circuit.

The power converter may comprise a controller for generating the described PWM signals and for controlling the various switches described throughout this document. The controller may form part of the feedback loop of the buck power converter circuit.

The power converter may comprise a first rectifier switch coupled between the first transformer terminal and an input of the buck power converter circuit. The power converter may be configured to control switching of the first buck switch and the first rectifier switch in synchronism. In other words, the power converter may be configured to apply the same control (PWM) signal to control terminals of the first buck switch and the first rectifier switch.

The power converter may be configured to control the first buck switch and the second buck switch such that the first buck switch is turned off if the second buck switch is turned on, and the second buck switch is turned off if the first buck switch is turned on. That is, the power converter may be configured to never turn on both buck switches at the same time. The power converter may be configured to alternately turn on the first buck switch and the second buck switch. The power converter may be configured to insert dead times between intervals in which one of the two buck switches is turned on.

The (primary side) switching bridge circuit may comprise a half-bridge circuit or a full-bridge circuit. The switching bridge circuit may comprise a high side switch coupled between a first input of the power converter and an input of the resonant tank circuit, and a low side switch coupled between the input of the resonant tank circuit and a second input of the power converter. The resonance capacitor of the resonance tank circuit may be coupled either to the switch node of the half-bridge or a low side input of the power converter.

The switches of the switching bridge circuit may be identical to, similar to, or different from the buck switches. In particular, the switches of the switching bridge circuit may have a higher voltage rating than the buck switches. For instance, the buck switches may have a voltage rating of 100V, and the switches of the switching bridge circuit may have a voltage rating of 600V. At this, the voltage rating denotes a maximum voltage a controlled section (or channel, such as e.g. the drain source channel of a MOSFET-switch) of a switch can withstand without damages.

The power converter may be configured to control an on-time of the first buck switch to be shorter than or equal to an on-time of the high side switch. The power converter may be configured to control the first buck switch and the high side switch with the same switching frequency. The power converter may be configured to control the first buck switch and the high side switch such that a duty cycle of the first buck switch is smaller than or equal to a duty cycle of the high side switch, wherein the term duty cycle refers to the ratio between on-time and off-time of the respective switch.

In particular, the power converter may be configured to control the high side switch and the first buck switch such that an on-time of the first buck switch is during an on-time of the high side switch.

The power converter may be configured to control the high side switch and the first buck switch such that all on-times of the first buck switch are during on-times of the high side switch. The other way round, the power converter may be configured to control the high side switch and the first buck switch such that an on-time of the first buck switch is never during a time interval during which the high side switch isn't continuously turned on. In yet other words, whenever the buck switch is turned on, the high side switch must be turned on, resulting in the buck switch having an equal or smaller duty cycle compared to the high side switch.

The power converter may be configured to control the high side switch and the low side switch of the switching bridge circuit such that the high side switch is turned off if the low side switch is turned on, and the low side switch is turned off if the high side switch is turned on. That is, the power converter may be configured to never turn on both the high side switch and the low side switch at the same time. The power converter may be configured to alternately turn on the high side and the low side switch. The power converter may be configured to insert dead times between intervals in which one of the two switches is turned on.

The power converter may comprise a second rectifier switch coupled between the first transformer terminal and a second output node of the power converter. The second output node may be e.g. a reference potential. The power converter may be configured to control switching of the second rectifier switch and the low side switch in synchronism. In other words, the power converter may be configured to apply the same control signal to control terminals of the second rectifier switch and the low side switch.

The rectifier switches described throughout this disclosure may be identical to, similar to, or different from the buck switches and the switches of the switching bridge circuit. In particular, the rectifier switches may have a lower voltage rating than the switches of the switching bridge circuit. For instance, the rectifier switches may have a voltage rating of 100V, and the switches of the switching bridge circuit may have a voltage rating of 600V.

The power converter may comprise a third rectifier switch coupled between the third transformer terminal and the second output node of the power converter. The power converter may be configured to control switching of the third rectifier switch and the high side switch in synchronism. In other words, the power converter may be configured to apply the same control signal to control terminals of the third rectifier switch and the high side switch.

The power converter may comprise a fourth rectifier switch coupled between the third transformer terminal and an input of the buck power converter circuit. Alternatively, the power converter may not comprise the fourth rectifier switch. In other words, there may be no direct electrical connection and no switching element between the input of the buck power converter circuit and the third transformer terminal.

In general, the rectifier switches may be configured to perform synchronous rectification of the signals generated by the resonant tank circuit and the transformer. Again, the rectifier switches may be implemented with any suitable devices, such as, for example, metal-oxide-semiconductor field effect transistors MOSFETs, insulated-gate bipolar transistors IGBTs, MOS-gated thyristors, or any other suitable power devices. For instance, the rectifier switches may be implemented using a III-V compound semiconductor material such as e.g. GaN-high-electron-mobility transistors HEMTs. Each rectifier switch may have a gate to which a respective driving voltage/current or control signal may be applied to turn the rectifier switch on (i.e. to close the rectifier switch) or to turn the rectifier switch off (i.e. to open the rectifier switch).

The power converter may comprise a first output capacitor coupled between the first output node of the power converter and the second transformer terminal. The power converter may comprise a second output capacitor coupled between the second transformer terminal and the second output node of the power converter. Moreover, the power converter may comprise a third output capacitor coupled between the first and the second output nodes of the power converter.

The resonant tank circuit may comprise a resonance capacitor coupled between the switching bridge circuit and the primary windings of the transformer. Specifically, the resonant tank circuit may also comprise a resonance inductor coupled in between the resonance capacitor and the primary windings of the transformer. Alternatively, the resonance inductor may be omitted, and the resonant tank circuit may solely rely on using a leakage inductance of the transformer as a resonance inductance. Moreover, the resonant tank circuit may also comprise a magnetizing inductor coupled in parallel to the primary windings of the transformer. That is, the magnetizing inductor may be coupled between a first terminal of the primary windings and a second terminal of the primary windings.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or indirectly connected via other circuit elements between them. For example, two elements may be said to be coupled even if there is a circuit element such as a switch (which may be turned on and off) in between them. On the other hand, the term “connect” or “connected” refers to elements being directly electrically connected with each other, e.g. via wires, and no circuit elements are located between them.

### BRIEF DESCRIPTION OF DRAWINGS

The present description is illustrated by way of example, and not by way of limitation, in the figures in which like reference numerals refer to similar or identical elements, and in which

FIG. 1 shows an exemplary circuit diagram of a power converter as discussed herein;

FIG. 2 shows an exemplary circuit diagram of another power converter as discussed herein; and

FIG. 3 shows control signals for the described power converters over time as discussed herein.

### DETAILED DESCRIPTION

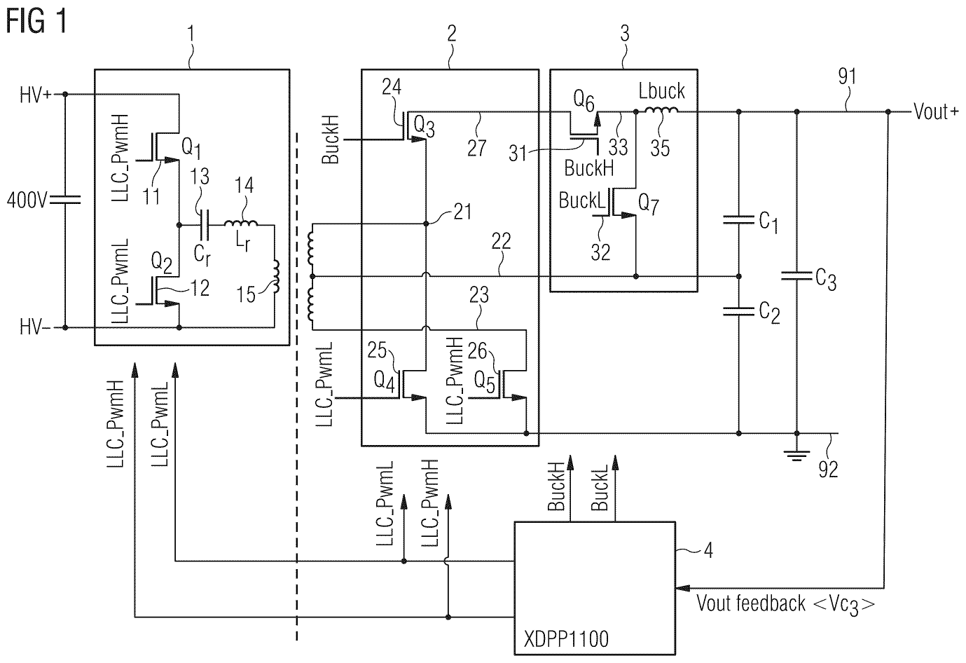

FIG. 1 shows an exemplary circuit diagram of a power converter as discussed herein. The power converter comprises an open loop LLC 1, a synchronous rectification unit 2, and a partially regulated buck converter 3. The latter units are controlled by controller 4 who is generating suitable PWM signals. For example, the PWM signals generated for the open loop LLC 1 and the synchronous rectification unit 2 may have a fixed duty cycle (such as e.g. 50%), whereas the PWM signals generated for the buck converter 3 are dynamically adjusted based on the output voltage Vout.

The open loop LLC 1 comprises a high side switch 11, a low side switch 12, and a resonance inductor 14 coupled in between the resonance capacitor 13 and the primary windings 15 of the transformer. In the SR unit 2, a first rectifier switch 24 is coupled between the first transformer terminal 21 and an input 27 of the buck converter 3 (buck power converter circuit). A second rectifier switch 25 is coupled between the first transformer terminal 21 and a second output node of the power converter 92. A third rectifier switch 26 is coupled between the third transformer terminal 23 and the second output node of the power converter 92.

The buck converter 3 comprises a first buck switch 31 coupled between the input 27 of the buck converter and a switching node 33, a second buck switch 32 coupled between the switching node 33 and the second transformer terminal 22, and an inductive element 35 between the switching node 33 and a first output node of the power converter 91.

To be more specific, controller 4 may generate a PWM signal LLC_PwmH for controlling switches 11 and 26, a PWM signal LLC_PwmL for controlling switches 12 and 25, a PWM signal BuckH for controlling switches 24 and 31, and a PWM signal BuckL for controlling switch 32.

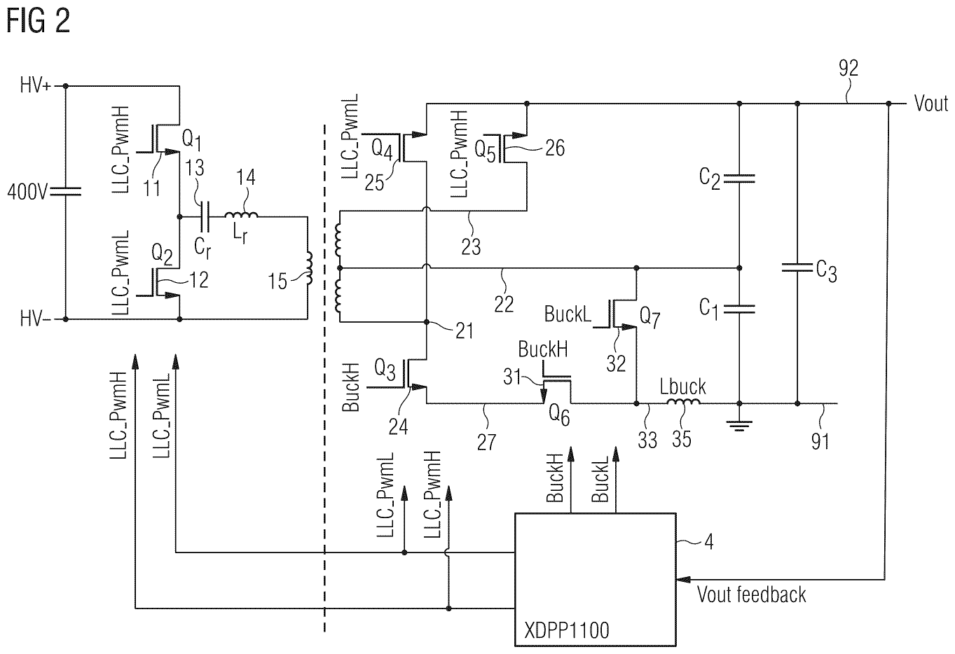

FIG. 2 shows an exemplary circuit diagram of another power converter as discussed herein. In the following, elements of FIG. 2 which are identical to those of FIG. 1 are not described and only the differences between both embodiments are emphasized. This time, the partially regulated buck is disposed in the lower half of the output stage. Again, a first rectifier switch 24 is coupled between the first transformer terminal 21 and an input 27 of the buck converter 3 (buck power converter circuit). A second rectifier switch 25 is coupled between the first transformer terminal 21 and a second output node of the power converter 92. A third rectifier switch 26 is coupled between the third transformer terminal 23 and the second output node of the power converter 92.

The buck converter 3 comprises a first buck switch 31 coupled between the input 27 of the buck converter and a switching node 33, a second buck switch 32 coupled between the switching node 33 and the second transformer terminal 22, and an inductive element 35 between the switching node 33 and a first output node of the power converter 91.

In summary, the presented DC-DC transformer has a partially regulated buck converter as the second stage to achieve a wide output voltage range while being capable of using lower voltage rated switches. It is observed that with properly synchronized PWM signals, one of the rectifier switches of a conventional SR stage can be eliminated by combination with the high side switching device of buck converter.

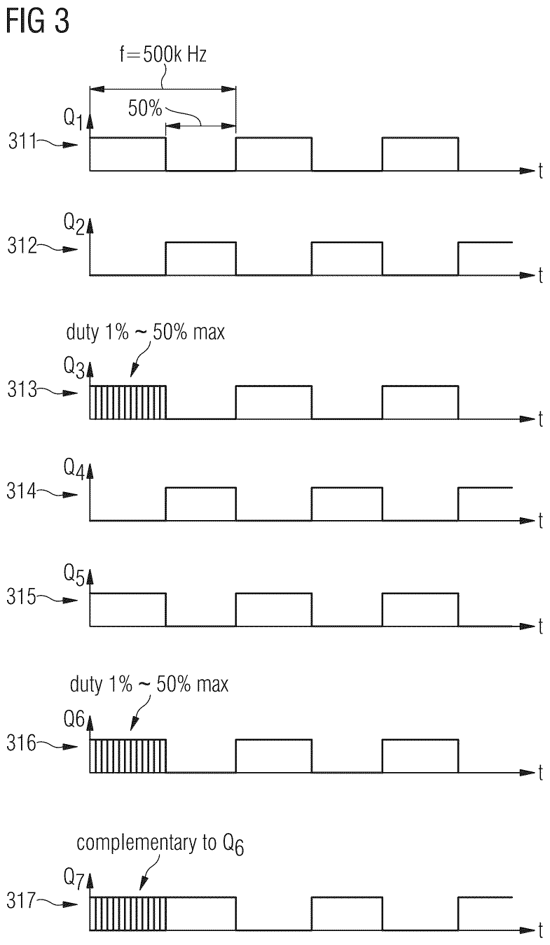

FIG. 3 shows exemplary control signals for the described power converters over time. Diagram 311 shows an exemplary PWM signal for controlling the high side switch Q1 of the switching bridge circuit. Diagram 312 shows an exemplary PWM signal for controlling the low side switch Q2 of the switching bridge circuit. The signals for Q1 and Q2 are complementary in this example. In general, however, these signals may comprise dead times for safer operation of the half-bridge. Diagram 313 shows an exemplary PWM signal for controlling the first rectifier switch Q3. The vertical lines within the first on-time interval indicate the different duty cycles of the PWM signal. In particular, the vertical lines indicate different falling edges of the first pulse, wherein the first raising edge starts at time 0. In general, each pulse may have the same shape as this exemplary first pulse, and each pulse may have a variable falling edge depending on the output voltage and a fixed raising edge. In this example, the duty cycles are in between 1% and 50%. The duty cycle may be adapted by the controller 4 based on the output voltage. Diagram 314 shows an exemplary PWM signal for controlling the second rectifier switch Q4 (which is identical to 312) and diagram 315 shows an exemplary PWM signal for controlling the third rectifier switch Q5 (which is identical to 311). Diagram 316 shows an exemplary PWM signal for controlling the first buck switch Q6. In this example, the duty cycles for Q6 are in between 1% and 50%. Again, the timing of the falling edge may vary depending on the output voltage. Diagram 317 shows an exemplary PWM signal for controlling the second buck switch Q7. In this example, the duty cycles for Q7 are in between 50% and 100% and the PWM may be complementary to the PWM signal controlling Q6. Thus, the PWM signal for controlling Q7 may have a variable raising edge timing depending on the output voltage, and the falling edge timing may be fixed.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1) A power converter configured to convert an input voltage into an output voltage, the power converter comprising:
a switching bridge circuit;
a transformer including: i) primary windings, ii) first secondary windings connected between a first transformer terminal and a second transformer terminal, and iii) second secondary windings connected between the second transformer terminal and a third transformer terminal;
a resonant tank circuit comprising the primary windings of the transformer; and
a buck power converter circuit coupled between the first secondary windings and an output of the power converter.

2) The power converter according to claim 2, wherein the buck power converter circuit comprises a first buck switch coupled between an input of the buck power converter circuit and a switching node, a second buck switch coupled between the switching node and the second transformer terminal, and an inductive element between the switching node and a first output node of the power converter.

3) The power converter according to claim 1, wherein the power converter is configured to adjust a duty-cycle of the buck power converter circuit based on the output voltage of the power converter.

4) The power converter according claim 1 further comprising a first rectifier switch coupled between the first transformer terminal and an input of the buck power converter circuit.

5) The power converter according to claim 4, wherein the power converter is configured to control switching of the first buck switch and the first rectifier switch in synchronism.

6) The power converter according to claim 5, wherein the power converter is configured to control the first buck switch and the second buck switch such that
the first buck switch is turned off when the second buck switch is turned on, and
the second buck switch is turned off when the first buck switch is turned on.

7) The power converter according to claim 1, wherein the switching bridge circuit comprises a half-bridge circuit or a full-bridge circuit.

8) The power converter according to claim 1, wherein the switching bridge circuit comprises a high side switch coupled between a first input of the power converter and an input of the resonant tank circuit, and a low side switch coupled between the input of the resonant tank circuit and a second input of the power converter.

9) The power converter according to claim 8, wherein the power converter is configured to control an on-time of the low side switch to be shorter than or equal to an on-time of the high side switch.

10) The power converter according to claim 8, wherein the power converter is configured to control the high side switch and the low side switch such that an on-time of the low side switch is off during an on-time of the high side switch.

11) The power converter according to claim 8, wherein the power converter is configured to control the high side switch and the low side switch such that
the high side switch is turned off when the low side switch is turned on, and
the low side switch is turned off when the high side switch is turned on.

12) The power converter according to claim 4, further comprising a second rectifier switch coupled between the first transformer terminal and a second output node of the power converter.

13) The power converter according to claim 12 further comprising a third rectifier switch coupled between the third transformer terminal and the second output node of the power converter.

14) The power converter according to claim 1 further comprising a fourth rectifier switch coupled between the third transformer terminal and an input of the buck power converter circuit.

15) The power converter according to claim 1, wherein the resonant tank circuit comprises a resonance capacitor coupled between the switching bridge circuit and the primary windings of the transformer.
